(19) United States
(12) Patent Application Publication
(10) Pub. No.: US 2023/0298119 A1
(43) Pub. Date: Sep. 21, 2023

(54) Method and Device for Intelligently Providing Recommendation Information

(71) Applicant: Siemens Aktiengesellschaft, München (DE)

(72) Inventors: Armin Roux, Erlangen (DE); Bin Zhang, Beijing (CN); Zhong Yang Sun, Beijing (CN); Shun Jie Fan, Beijing (CN); Ming Jie, Beijing (CN)

(73) Assignee: Siemens Aktiengesellschaft, München (DE)

(21) Appl. No.: 18/041,472

(22) PCT Filed: Aug. 14, 2020
(86) PCT No.: PCT/CN2020/109354

§ 371 Date: Feb. 13, 2023

(51) Int. Cl. G06Q 50/20; G06Q 10/0639

(52) U.S. Cl. CPC G06Q 50/2057; G06Q 10/06398

(57) ABSTRACT

Various embodiments include methods for intelligently providing recommendation information. For example, the method may include: determining user attribute parameters corresponding to a user identifier; determining a score value corresponding to the user identifier by inputting the user attribute parameters into a scoring model; determining recommendation information corresponding to the user identifier based on the score value and a knowledge graph related to the user; and providing the recommended information.

### CROSS-REFERENCE TO RELATED APPLICATIONS

This application is a U.S. National Stage Application of International Application No. PCT/CN2020/109354 filed Aug. 14, 2020, which designates the United States of America, the contents of which are hereby incorporated by reference in their entirety.

### TECHNICAL FIELD

The present disclosure relates to the field of artificial intelligence technology. Various embodiments of the teachings herein include methods and/or devices for intelligently providing recommended information.

### BACKGROUND

For factory managers, how to improve the skill level of workers is a significant problem. Managers are committed to continuously improving the skill level of workers. Workers need smart learning methods, which can enable workers to learn independently, thereby reducing the cost of manual training, training time and the loss of skills due to the loss of workers (such as retirement).

The existing learning methods for workers mainly rely on an master-apprentice system. Master and apprentice transfer knowledge through face-to-face communication. Other learning methods for workers are mainly conducted through social media, such as video learning, online real-time learning, and Internet forums. However, the above methods have following problems: the training period of the master-apprentice system is long, the learning efficiency also depends on the master's teaching level, and the master-apprentice system will inevitably affect the master's own production capacity. In addition, learning systems related to social media have many problems, such as cumbersome learning content and workers' inability to accurately find what they need to learn. Also, workers often don't know what skills they need to learn.

AI (Artificial intelligence) has a major impact on all walks of life. Manufacturers have begun to recognize and experience the advantages of AI.

### SUMMARY

The teachings of the present disclosure include methods and/or devices for intelligently providing recommendation information. For example, some embodiments include a method (100) for intelligently providing recommendation information, comprising: determining (102) user attribute parameters corresponding to a user identifier; determining (104) a score value corresponding to the user identifier by inputting the user attribute parameters into a scoring model; determining (106) recommendation information corresponding to the user identifier based on the score value and a knowledge graph related to the user; and providing (108) the recommended information.

In some embodiments, determining (102) user attribute parameters corresponding to a user identifier comprises at least one of the following: obtaining working time corresponding to the user identifier from a user information database; obtaining historical task amount corresponding to the user identifier from a user information database; obtaining current task corresponding to the user identifier from a user information database; obtaining a skill level value corresponding to the user identifier from a user information database; obtaining training time corresponding to the user identifier from a user information database; and/or obtaining the number of skills corresponding to the user identifier from the knowledge graph.

In some embodiments, the user attribute parameters include multiple categories, and the scoring model is a trained machine learning model including multiple dimensions, wherein each dimension corresponds to each category of the user attribute parameters.

In some embodiments, the knowledge graph includes user entities, skill entities and operation object entities; wherein the data source used to construct the knowledge graph includes at least one of the following: structured data; unstructured data; and/or semi-structured data.

In some embodiments, determining (106) recommendation information corresponding to the user identifier based on the score value and a knowledge graph related to the user comprises: determining a skill set corresponding to the level range to which the score value belongs; determining a skill corresponding to the user identifier stored in the knowledge graph; removing the skill corresponding to the user identifier from the skill set; and determining the recommended information corresponding to the user identifier based on the remaining skills in the skill set; or determining a similar user with a score value similar to the score value; determining a skill corresponding to the user identifier of the similar user stored in the knowledge graph; and determining the recommendation information corresponding to the user identifier based on the skill corresponding to the user identifier of the similar user; or determining a similar user who is similar to the user corresponding to the user identifier based on the knowledge graph; determining a skill corresponding to the user identifier of the similar user stored in the knowledge graph; determining the recommendation information corresponding to the user identifier based on the skill corresponding to the user identifier of the similar user.

In some embodiments, determining (106) recommendation information corresponding to the user identifier based on the score value and a knowledge graph related to the user comprises: determining a first set of similar users based on the knowledge graph, wherein the first set of similar users includes similar users of the user corresponding to the user identifier; determining a second set of similar users based on a score value comparison process, wherein the second set of similar users includes similar users of the user corresponding to the user identifier; determining the intersection of the first set of similar users and the second set of similar users; and determining the recommendation information corresponding to the user identifier based on a skill of the users in the intersection stored in the knowledge graph and a skill of the user corresponding to the user identifier stored in the knowledge graph.

As another example, some embodiments include a device (600) for intelligently providing recommendation information, comprising: a first determining module (601), configured to determine user attribute parameters corresponding to a user identifier; a second determining module (602), configured to determine a score value corresponding to the user identifier by inputting the user attribute parameters into a scoring model; a third determining module (603), configured to determine recommendation information corresponding to the user identifier based on the score value and a knowledge graph related to the user; and a providing module (604), configured to provide the recommended information.

In some embodiments, the first determining module (601), configured to execute at least one of the following: obtaining working time corresponding to the user identifier from a user information database; obtaining historical task amount corresponding to the user identifier from a user information database; obtaining current task corresponding to the user identifier from a user information database; obtaining a skill level value corresponding to the user identifier from a user information database; obtaining training time corresponding to the user identifier from a user information database; and/or obtaining the number of skills corresponding to the user identifier from the knowledge graph.

In some embodiments, the user attribute parameters include multiple categories and the scoring model is a trained machine learning model including multiple dimensions, wherein each dimension corresponds to each category of the user attribute parameters.

In some embodiments, the knowledge graph includes user entities, skill entities, and operation object entities; wherein the data source used to construct the knowledge graph includes at least one of the following: structured data; unstructured data; and/or semi-structured data.

In some embodiments, the third determining module (603), is configured to: determine a skill set corresponding to the level range to which the score value belongs; determine a skill corresponding to the user identifier stored in the knowledge graph; remove the skill corresponding to the user identifier from the skill set; and determine the recommended information corresponding to the user identifier based on the remaining skills in the skill set; or determine a similar user with a score value similar to the score value; determine a skill corresponding to the user identifier of the similar user stored in the knowledge graph; and determine the recommendation information corresponding to the user identifier based on the skill corresponding to the user identifier of the similar user; or determine a similar user who is similar to the user corresponding to the user identifier based on the knowledge graph; determine a skill corresponding to the user identifier of the similar user stored in the knowledge graph; determine the recommendation information corresponding to the user identifier based on the skill corresponding to the user identifier of the similar user.

In some embodiments, the third determining module (603) is configured to determine a first set of similar users based on the knowledge graph, wherein the first set of similar users includes similar users of the user corresponding to the user identifier; determine a second set of similar users based on a score value comparison process, wherein the second set of similar users includes similar users of the user corresponding to the user identifier; determine the intersection of the first set of similar users and the second set of similar users; and determine the recommendation information corresponding to the user identifier based on a skill of the users in the intersection stored in the knowledge graph and a skill of the user corresponding to the identifier stored in the knowledge graph.

As another example, some embodiments include a device (700) for intelligently providing recommendation information, comprising a processor (701) and a memory (702), wherein an application program executable by the processor (701) is stored in the memory (702) for causing the processor (701) to execute one or more methods (100) for intelligently providing recommendation information as described herein.

As another example, some embodiments include a computer-readable medium comprising computer-readable instructions stored thereon, wherein the computer-readable instructions for executing one or more methods (100) for intelligently providing recommendation information as described herein.

### BRIEF DESCRIPTION OF THE DRAWINGS

In order to make technical examples of the teachings of the present disclosure clearer, accompanying drawings to be used in description of the examples are introduced hereinafter. Obviously, the accompanying drawings to be described hereinafter are only some examples of the present disclosure. Those skilled in the art may obtain other drawings according to these accompanying drawings without creative labor. In the drawings:

FIG. 1 is a flowchart of a method for intelligently providing recommendation information incorporating teachings of the present disclosure;

FIG. 2 is an exemplary schematic diagram of constructing a knowledge graph incorporating teachings of the present disclosure;

FIG. 3 is a first exemplary schematic diagram of a user-related knowledge graph incorporating teachings of the present disclosure;

FIG. 4 is a second exemplary schematic diagram of a user-related knowledge graph incorporating teachings of the present disclosure;

FIG. 5 is a flowchart of an exemplary method for intelligently providing recommendation information in a worker training scenario incorporating teachings of the present disclosure;

FIG. 6 is a block diagram of a device for intelligently providing recommendation information incorporating teachings of the present disclosure; and

FIG. 7 is a block diagram of a device for intelligently providing recommendation information incorporating teachings of the present disclosure.

### LIST OF REFERENCE NUMBERS

| reference numbers | meanings |
|---|---|
| 100 | method for intelligently |
| | providing recommendation |
| | information |
| 102, 104, 106, 108 | steps |
| 20 | data source |
| 21 | document |
| 22 | image |
| 23 | audio |
| 24 | video |
| 25 | image identification |
| 26 | text extraction |
| 27 | speech recognition |
| 28 | audio extraction |
| 29 | speech recognition |
| 30 | semantic analysis system based |
| | on natural language processing |
| | (NLP) |
| 60 | ontology data |
| 31 | first user entity |
| 32 | second user entity |
| 33 | third user entity |
| 41 | first skill entity |
| 42 | second skill entity |
| 43 | third skill entity |
| 51 | first machine entity |
| 52 | second machine entity |
| 501~510 | steps |
| 600 | device for intelligently |
| | providing recommendation |
| | information |
| 601 | first determining module |
| 602 | second determining module |
| 603 | third determining module |
| 604 | providing modules |
| 700 | device for intelligently |
| | providing recommendation |
| | information |
| 701 | processor |
| 702 | memory |

### DETAILED DESCRIPTION

In some embodiments of the teachings herein, a method for intelligently providing recommendation information comprises: determining user attribute parameters corresponding to a user identifier; determining a score value corresponding to the user identifier by inputting the user attribute parameters into a scoring model; determining recommendation information corresponding to the user identifier based on the score value and a knowledge graph related to the user; and providing the recommended information. Therefore, recommendation information can be provided intelligently based on the knowledge graph and scoring model, which is beneficial to improve learning efficiency.

In some embodiments, determining user attribute parameters corresponding to a user identifier comprises at least one of the following: obtaining working time corresponding to the user identifier from a user information database; obtaining historical task amount corresponding to the user identifier from a user information database; obtaining current task corresponding to the user identifier from a user information database; obtaining a skill level value corresponding to the user identifier from a user information database; obtaining training time corresponding to the user identifier from a user information database; and/or obtaining the number of skills corresponding to the user identifier from the knowledge graph. Therefore, multiple types of user attribute parameters can be obtained from multiple data sources. In some embodiments, the user attribute parameters include multiple categories, and the scoring model is a trained machine learning model including multiple dimensions, wherein each dimension corresponds to each category of the user attribute parameters. Thus, the user attribute parameters are kept corresponding to the dimensions in the machine learning model, which is beneficial to quickly obtain score value.

In some embodiments, the knowledge graph includes user entities, skill entities and operation object entities; and the data source used to construct the knowledge graph includes at least one of the following: structured data; unstructured data; and/or semi-structured data. Therefore, a knowledge graph can be constructed from multiple data sources.

In some embodiments, determining recommendation information corresponding to the user identifier based on the score value and a knowledge graph related to the user comprises: determining a skill set corresponding to the level range to which the score value belongs; determining a skill corresponding to the user identifier stored in the knowledge graph; removing the skill corresponding to the user identifier from the skill set; and determining the recommended information corresponding to the user identifier based on the remaining skills in the skill set; or determining a similar user with a score value similar to the score value; determining a skill corresponding to the user identifier of the similar user stored in the knowledge graph; and determining the recommendation information corresponding to the user identifier based on the skill corresponding to the user identifier of the similar user; or determining a similar user who is similar to the user corresponding to the user identifier based on the knowledge graph; determining a skill corresponding to the user identifier of the similar user stored in the knowledge graph; determining the recommendation information corresponding to the user identifier based on the skill corresponding to the user identifier of the similar user. Therefore, recommendation information can be generated in a variety of ways, which has the advantage of wide applicability.

In some embodiments, determining recommendation information corresponding to the user identifier based on the score value and a knowledge graph related to the user comprises: determining a first set of similar users based on the knowledge graph, wherein the first set of similar users includes similar users of the user corresponding to the user identifier; determining a second set of similar users based on a score value comparison process, wherein the second set of similar users includes similar users of the user corresponding to the user identifier; determining the intersection of the first set of similar users and the second set of similar users; and determining the recommendation information corresponding to the user identifier based on a skill of the users in the intersection stored in the knowledge graph and a skill of the user corresponding to the user identifier stored in the knowledge graph. Therefore, the knowledge graph and the score value output by the scoring model are combined to determine the recommendation information more intelligently. In particular, the knowledge graph helps to find a correlation between different entities, so that recommendation information can be jointly determined based on the two dimensions of employee ability and employee similarity.

In some embodiments, a device for intelligently providing recommendation information comprises: a first determining module, configured to determine user attribute parameters corresponding to a user identifier; a second determining module, configured to determine a score value corresponding to the user identifier by inputting the user attribute parameters into a scoring model; a third determining module, configured to determine recommendation information corresponding to the user identifier based on the score value and a knowledge graph related to the user; and a providing module, configured to provide the recommended information. Therefore, recommendation information can be provided intelligently based on the knowledge graph and scoring model, which is beneficial to improve learning efficiency.

In some embodiments, the first determining module is further configured to execute at least one of the following: obtaining working time corresponding to the user identifier from a user information database; obtaining historical task amount corresponding to the user identifier from a user information database; obtaining current task corresponding to the user identifier from a user information database; obtaining a skill level value corresponding to the user identifier from a user information database; obtaining training time corresponding to the user identifier from a user information database; and obtaining the number of skills corresponding to the user identifier from the knowledge graph. Therefore, multiple types of user attribute parameters can be obtained from multiple data sources.

In some embodiments, the user attribute parameters include multiple categories and the scoring model is a trained machine learning model including multiple dimensions, wherein each dimension corresponds to each category of the user attribute parameters. Thus, the user attribute parameters are kept corresponding to the dimensions in the machine learning model, which is beneficial to quickly obtain score value.

In some embodiments, the knowledge graph includes user entities, skill entities, and operation object entities; and the data source used to construct the knowledge graph includes at least one of the following: structured data; unstructured data; and/or semi-structured data. Therefore, a knowledge graph can be constructed from multiple data sources.

In some embodiments, the third determining module is further configured to: determine a skill set corresponding to the level range to which the score value belongs; determine a skill corresponding to the user identifier stored in the knowledge graph; remove the skill corresponding to the user identifier from the skill set; and determine the recommended information corresponding to the user identifier based on the remaining skills in the skill set; or determine a similar user with a score value similar to the score value; determine a skill corresponding to the user identifier of the similar user stored in the knowledge graph; and determine the recommendation information corresponding to the user identifier based on the skill corresponding to the user identifier of the similar user; or determine a similar user who is similar to the user corresponding to the user identifier based on the knowledge graph; determine a skill corresponding to the user identifier of the similar user stored in the knowledge graph; determine the recommendation information corresponding to the user identifier based on the skill corresponding to the user identifier of the similar user. Therefore, recommendation information can be generated in a variety of ways, which has the advantage of wide applicability.

In some embodiments, the third determining module is further configured to determine a first set of similar users based on the knowledge graph, wherein the first set of similar users includes similar users of the user corresponding to the user identifier; determine a second set of similar users based on a score value comparison process, wherein the second set of similar users includes similar users of the user corresponding to the user identifier; determine the intersection of the first set of similar users and the second set of similar users; and determine the recommendation information corresponding to the user identifier based on a skill of the users in the intersection stored in the knowledge graph and a skill of the user corresponding to the identifier stored in the knowledge graph. Therefore, the knowledge graph and the score value output by the scoring model are combined to determine the recommendation information more intelligently. In particular, the knowledge graph helps to find a correlation between different entities, so that recommendation information can be jointly determined based on the two dimensions of employee ability and employee similarity.

In some embodiments, a device for intelligently providing recommendation information comprises a processor and a memory, wherein an application program executable by the processor is stored in the memory for causing the processor to execute a method for intelligently providing recommendation information as described herein.

In some embodiments, there is a computer-readable medium comprising computer-readable instructions stored thereon, wherein the computer-readable instructions for executing a method for intelligently providing recommendation information as described herein.

For the sake of brevity and clarity of the description, the aspects of the teachings of the present disclosure are set forth below by describing several representative embodiments. Numerous details in the embodiments are only configured to assist in understanding the aspects of the present disclosure. However, it is obvious that the technical solutions can be implemented without being limited to these details. In order to avoid unnecessarily obscuring aspects of the present disclosure, some embodiments are not described in detail, but only the framework is given. Hereinafter, “including” means “including but not limited to”, and “according to” means “at least according to . . . , but not limited to only based on”. Due to the language habit of Chinese, the number of one component is not specifically indicated below, which means that the component may be one or more, or may be understood as at least one.

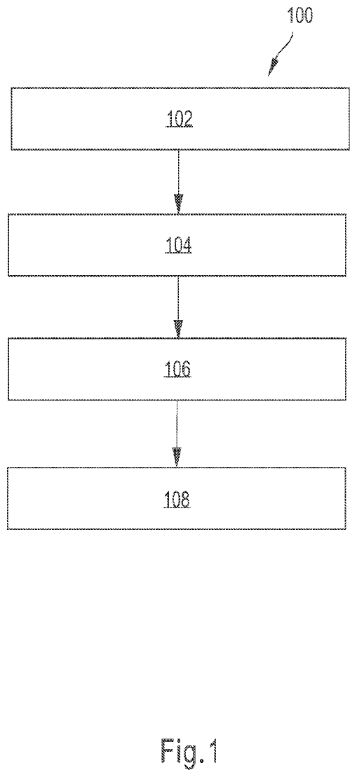

FIG. 1 is a flowchart of a method for intelligently providing recommendation information incorporating teachings of the present disclosure. As shown in FIG. 1, the method 100 includes:

Step 102: Determining user attribute parameters corresponding to a user identifier. Here, the user identifier is a name used to identify a user when the user logs in. For example, the user identifier can be a worker number, student ID number, teacher ID number, Subscriber Identity Module (SMI) card number of a mobile terminal, and so on. The user attribute parameters include parameters related to the user's ability attributes. For example, the ability attributes of the user may include: the skills and the number of skills the user has mastered; tasks that the user has completed; tasks that the user is currently performing, and so on. Specifically, the user attribute parameters may include: working time, historical task amount, current task, number of skills mastered, skill level value (for example, set by the boss), training time, and so on.

In one embodiment, in step 102, the user identifier can be used as a retrieval item and structured user attribute parameters corresponding to the user identifier can be obtained from various types of structured databases. For example, structured user attribute parameters can be obtained from various types of structured databases such as personnel resource databases and work log databases.

In some embodiments, it is also possible to obtain unstructured user attribute parameters from unstructured data sources (for example, email messages, chat records, office documents, text, pictures, XML files, HTML files, and various reports). Preferably, further normalization processing is performed on unstructured user attribute parameters, so as to facilitate subsequent unified processing.

Step 104: Determining a score value corresponding to the user identifier by inputting the user attribute parameters into a scoring model. Here, the user attribute parameters obtained in step 102 are input into a predetermined scoring model, so that the scoring model outputs a score value corresponding to the user identifier.

In some embodiments, the user attribute parameter includes multiple categories, and the scoring model is a trained machine learning model including multiple dimensions, wherein each dimension corresponds to each category of the user attribute parameters. The score model uses the user attribute parameters provided by each user to score each user, thereby outputting the score value of each user. For example, the machine learning model can be specifically implemented as a linear regression model or a nonlinear model, where the nonlinear model may include: a fully connected neural network, a convolutional neural network, or a cyclic neural network, and so on. The following takes linear regression model as an example to describe typical examples of establishing and training machine learning models.

Firstly, establishing a scoring model, comprising: defining eigenvalues x₁, x₂, x₃ . . . xₙ, which includes defining number and choosing every eigenvalue. Then statistics into a data table, column named eigenvalue, row named personnel ID (that is, user identifier). Each eigenvalue corresponds to each category of user attribute parameters.

Examples of eigenvalues: (1). Worker's working life: obtained from worker information database; (2). Worker Task Volume: The difficulty coefficient is given according to the difficulty degree of the task. The difficulty coefficient is multiplied by the sum of the number of workpieces. (3). Number of skills: acquired from knowledge graph. Get the initial data set and randomly divide it into training set and test set. Initial data include all the workers' eigenvalues and worker level rates(y) which are obtained by employee KPI, rating and voting manually.

Secondly, establishing a weight matrix and calculating the weight matrix with the training set. Specifically, establishing a linear regression algorithm model, each data has n eigenvalues which already defined before, each feature corresponds to its own weight value(ω), and the product of weight plus a bias value(b), this is the linear regression model, the formula is as follows: y=ω₁*x₁+ω₂*x₂+ . . . +ωₙ*xₙ+b.

In order to facilitate the subsequent writing of matrix form, we can modify this side slightly, so that ω₀=b, x₀=1 can be written in the following form: y=ω₀*x₀+ω₁*x₁+ω₂*x₂+ . . . +ωₙ*xₙ.

Assuming that there are m samples in training set, the form of matrix is as follows:

$$X = [ \begin{matrix}1 & {x}_{1}^{1} & {x}_{1}^{2} & … & {x}_{1}^{n} \\ 1 & {x}_{2}^{1} & {x}_{2}^{2} & … & {x}_{2}^{n} \\ ⋮ & … & … & ⋱ & ⋮ \\ 1 & {x}_{m}^{1} & {x}_{m}^{2} & … & {x}_{m}^{n}\end{matrix} ] \qquad Y = [ \begin{matrix}{y}_{1} \\ {y}_{2} \\ … \\ {y}_{m}\end{matrix} ]$$

The weight matrix W can also be written in the form of a matrix:

W=[ω₀ ω₁ ω₂ . . . ωₙ]

Then it can be written in a simple and clear way:

Y=XW^{T}

Calculating the weight matrix W and then defining the linear regression algorithm model which used for calculate new score value.

Thirdly, verifying the model with test set, updating and optimizing the model. Use Root Mean Square Error (RMSE) to update the model by test set. RMSE is as follows:

$$RMSE = \sqrt{\frac{1}{N} {\sum }_{i = 1}^{N} {( {\hat{y}}_{i} - {y}_{i} )}^{2}} ;$$

wherein ŷᵢ is predicted value which from model result. yᵢ is real value which from test set.

The above exemplarily describes a typical example of establishing and training a linear regression model. Those skilled in the art can realize that this description is only exemplary and is not used to limit the protection scope of the embodiments of the present disclosure.

Step 106: Determining recommendation information corresponding to the user identifier based on the score value and a knowledge graph related to the user.

In some embodiments, the knowledge graph includes user entities, skill entities, and operation object entities; wherein the data source used to construct the knowledge graph includes at least one of the following: structured data; unstructured data; semi-structured data. For example, structured user data can be obtained from structured databases such as a personnel resource database and a work log database to serve as a data source for constructing a knowledge graph. Optionally, unstructured user data can also be obtained from unstructured data sources, etc., as a data source for constructing a knowledge graph.

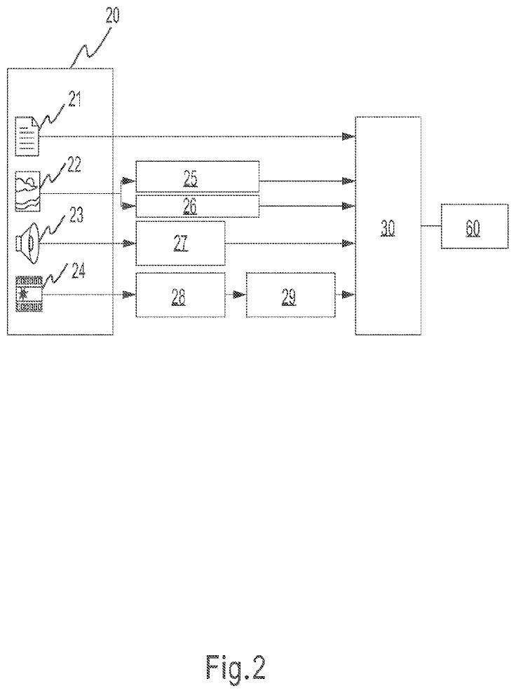

FIG. 2 is an exemplary schematic diagram of constructing a knowledge graph incorporating teachings of the present disclosure. As shown in FIG. 2, the data source 20 includes multiple types, specifically including document 21, image 22, audio 23 and video 24. Among them, texts contained in the document 21 can be input to NLP-based semantic analysis system 30. The image recognition 25 performs image recognition processing on the picture 22, and inputs the image recognition result (text description of the image) into NLP-based semantic analysis system 30. The voice recognition 27 performs voice recognition processing on the audio 23, and inputs the voice recognition result into NLP-based semantic analysis system 30. Audio is first extracted from video 24 based on the audio extraction 28, then speech recognition 29 is performed on the extracted audio, and result of the speech recognition is input to NLP-based semantic analysis system 30.

It can be seen that the NLP-based semantic analysis system 30 has multiple text input sources. The NLP-based semantic analysis system 30 executes NLP processing to extract ontology data 60. Then, based on the ontology data 60, a knowledge graph including user entities, skill entities, and operation target entities can be created. For example, tools such as Neo4j or MongoDB can be used to create knowledge graphs. Among them, the user entity may contain a triple represented as <user ID, user attribute, user attribute value>; the skill entity may contain a triple represented as <skill ID, skill attribute, skill attribute value>; the operation target entity may contain triples represented as <operation target identifier, operation target attribute, operation target attribute value>. Preferably, the knowledge graph is in a dynamic update state.

Step 106: Providing the recommended information. For example, providing the recommended information to the user corresponding to the user identifier. Here, the recommended information can be presented in multiple ways such as video, audio, photos or text.

In some embodiments, wherein determining recommendation information corresponding to the user identifier based on the score value and a knowledge graph related to the user comprises: determining a skill set corresponding to the level range to which the score value belongs; determining a skill corresponding to the user identifier stored in the knowledge graph; removing the skill corresponding to the user identifier from the skill set; and determining the recommended information corresponding to the user identifier based on the remaining skills in the skill set.

In some embodiments, wherein determining recommendation information corresponding to the user identifier based on the score value and a knowledge graph related to the user comprises: determining a similar user with a score value similar to the score value; determining a skill corresponding to the user identifier of the similar user stored in the knowledge graph; and determining the recommendation information corresponding to the user identifier based on the skill corresponding to the user identifier of the similar user.

In some embodiments, wherein determining recommendation information corresponding to the user identifier based on the score value and a knowledge graph related to the user comprises: determining a similar user who is similar to the user corresponding to the user identifier based on the knowledge graph; determining a skill corresponding to the user identifier of the similar user stored in the knowledge graph; determining the recommendation information corresponding to the user identifier based on the skill corresponding to the user identifier of the similar user.

In some embodiments, wherein determining recommendation information corresponding to the user identifier based on the score value and a knowledge graph related to the user comprises: determining a first set of similar users based on the knowledge graph, wherein the first set of similar users includes similar users of the user corresponding to the user identifier; determining a second set of similar users based on a score value comparison process, wherein the second set of similar users includes similar users of the user corresponding to the user identifier; determining the intersection of the first set of similar users and the second set of similar users; and determining the recommendation information corresponding to the user identifier based on a skill of the users in the intersection stored in the knowledge graph and a skill of the user corresponding to the user identifier stored in the knowledge graph.

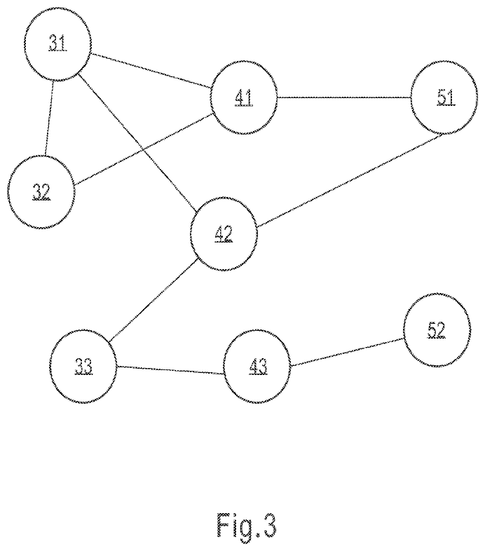

FIG. 3 is a first exemplary schematic diagram of a user-related knowledge graph in an embodiment of the present invention. In the knowledge graph shown in FIG. 3, entity 31 is an entity of the first user (for example, user identifier is E61); entity 32 is an entity of the second user (for example, user identifier is E62); and entity 33 is an entity of the third user (For example, user identifier is E63). The entity 31 is connected to the first machine entity 51 via first skill entity 41(for example, this means that the entity 31 has operated the first machine entity with the first skill, similar to the following); entity 31 is connected to the first machine entity 51 via second skill entity 42; entity 32 is connected to the first machine entity 51 via first skill entity 41; entity 33 It is connected to first machine entity 51 via second skill entity 42; entity 33 is connected to second machine entity 52 via third skill entity 43.

Among them: predefined level ranges of the score include: (0˜60), (61˜80), (81˜100). The level range (0˜60) belongs to low-level skills, and the corresponding skill set comprising (first skill entity 41, second skill entity 42); the level range (61˜80) belongs to medium-level skills, and the corresponding skill set comprising (the first skill entity 41, the third skill entity 43); the level range (81˜100) belongs to high-level skills, and the corresponding skill set comprising (first skill entity 41, second skill entity 42 and third skill entity 43).

After user E62 corresponding to the entity 32 logs in to a worker task system, the score value of the user E62 is determined to be 50 based on the scoring model. Therefore, user E62 belongs to the level range (0-60), and the corresponding skill set is (first skill entity 41, second skill entity 42). It is found through the knowledge graph that entity 32 is connected to first machine entity 51 via first skill entity 41, so user E62 corresponding to entity 32 has mastered the first skill entity 41. Then, the first skill entity 41 is removed from the corresponding skill set, and the remaining skill is: the second skill entity 42. Therefore, the training information related to the second skill entity 42 is recommended to the user E62 corresponding to the entity 32. For example, the training information may include: video files about user E63 using the second skill entity 42 to operate first machine entity 1; introduction audios of second skill entity 42; introduction picture of second skill entity 42; introduction text of second skill entity 42, and so on.

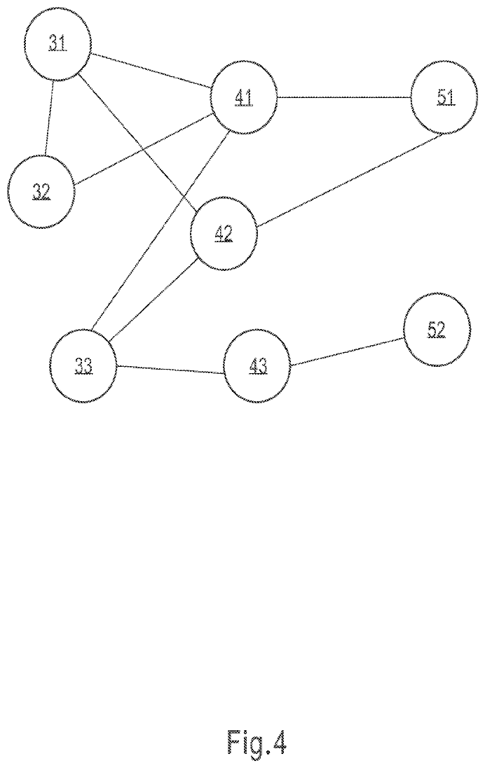

FIG. 4 is a second exemplary schematic diagram of a user-related knowledge graph incorporating teachings of the present disclosure. In the knowledge graph shown in FIG. 4, entity 31 is an entity of the first user (for example, user identifier is E61); entity 32 is an entity of the second user (for example, user identifier is E62); and entity 33 is an entity of the third user (For example, user identifier is E63). The entity 31 is connected to the first machine entity 51 via first skill entity 41 (for example, this means that the entity 31 has operated the first machine entity with the first skill, similar to the following); entity 31 is connected to the first machine entity 51 via second skill entity 42; entity 32 is connected to the first machine entity 51 via first skill entity 41; entity 33. It is connected to first machine entity 51 via second skill entity 42; entity 33 is connected to second machine entity 52 via third skill entity 43; entity 33 is connected to first machine entity 51 via first skill entity 41.

Example (1): When each user logs out of the system, the score value calculated this time is saved in a score database. When user E61 corresponding to entity 31 logs in to the system, score value of user E61 is determined to be 80 based on the scoring model. After querying the score database, it is determined that the user whose score value is similar to that of user E61 (i.e., similar user) is: E63 corresponding to entity 33. Discovered through the knowledge graph; entity 33 is connected to first machine entity 51 via second skill entity 42; entity 33 is connected to second machine entity 52 via third skill entity 43; entity 33 is connected to first machine entity 51 via first skill entity 41. It can be seen that user E63 corresponding to entity 33 has a first skill entity 41, a second skill entity 42 and a third skill entity 43. Moreover, entity 31 is connected to first machine entity 51 via first skill entity 41; entity 31 is connected to first machine entity 51 via second skill entity 42. It can be seen that user E61 corresponding to entity 31 has first skill entity 41 and second skill entity 42. Therefore, second skill entity 42 is a skill that the entity 31 does not possess but is possessed by the similar user. Therefore, training information related to the third skill entity 43 is recommended to user E61 corresponding to entity 31. For example, training information may include: video files of user E63 using third skill entity 43 to operate second machine entity 52; introduction audio of third skill entity 43; introduction picture of third skill entity 43; introduction text of third skill entity 43, and so on.

Example (2): When each user logs out of the system, the score value calculated this time is saved in a score database. When user E61 corresponding to the entity 31 logs in to the system, first, based on the knowledge graph, the first set of similar users similar to user E61 is determined. The attributes of each user entity in the knowledge graph can be queried to determine the user set having the same attributes as user E61, that is, the first similar user set. For example, it is found that user E62, user E63 and user E61 have the same attributes (for example, belong to the same workshop), so user E62 and user E63 are determined to be similar users of user E61. Then, based on a score value comparison process, it is determined that score value of user E63 (for example, the score value calculated when E63 last logged in) is similar to score value of user E61, so it is determined that the second set of similar users includes user E63. Then, it is determined that the intersection of the first set of similar users and the second set of similar users is user E63. It is also found through the knowledge graph that entity 33 is connected to first machine entity 51 via second skill entity 42; entity 33 is connected to second machine entity 52 via third skill entity 43; entity 33 is connected to first machine entity 51 via first skill entity 41. It can be seen that user E63 corresponding to entity 33 has a first skill entity 41, a second skill entity 42 and a third skill entity 43. Moreover, entity 31 is connected to first machine entity 51 via first skill entity 41; entity 31 is connected to first machine entity 51 via second skill entity 42. It can be seen that the user E61 corresponding to entity 31 has first skill entity 41 and second skill entity 42. Therefore, third skill entity 43 is a skill that entity 31 does not possess, but is possessed by the user in the intersection (user E63). Training information related to third skill entity 43 may be recommended to user E61 corresponding to entity 31. For example, training information may include: video files of user E63 using third skill entity 43 to operate second machine entity 52; introduction audio of third skill entity 43; introduction picture of third skill entity 43; introduction text of third skill entity 43, and so on.

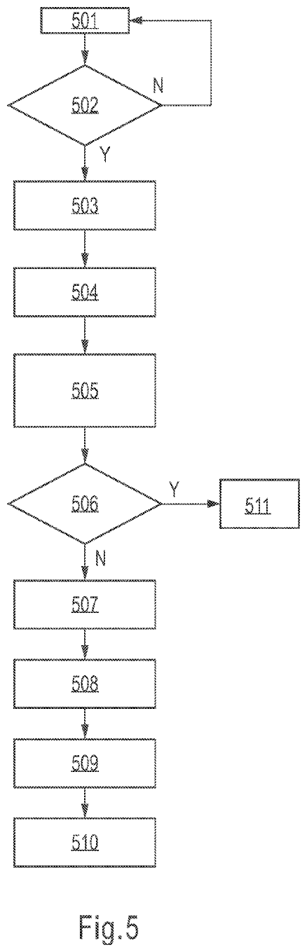

The following takes a worker training scenario as an example to describe an exemplary process of the implementation of the present disclosure. FIG. 5 is a flowchart of an exemplary method for intelligently providing recommendation information in a worker training scenario incorporating teachings of the present disclosure. As shown in FIG. 5, the method includes:

Step 501: A worker enters worker number and password to log in to a worker management system.

Step 502: determining whether the password is correct, if it is, performing step 503 and subsequent steps, otherwise, returning to step 501.

Step 503: determining a set of similar workers containing similar workers by a scoring model. Specifically, it includes: retrieving respective attribute parameters corresponding to each dimension in the scoring model based on the worker number, such as working time, historical task volume, number of skills mastered, and so on. Then, inputting the retrieved attribute parameters into the scoring model to determine the worker's score value. Then, the workers in the factory that are in the same level range are determined to be similar workers, thereby obtaining a set of similar workers.

Step 504: using a knowledge graph to determine workers with high similarity from the set of similar workers. Specifically: based on a similarity comparison of user attribute values of user entities in the knowledge graph, workers with higher similarity are furtherly determined from the set of similar workers. For example, workers in the same workshop are regarded as workers with higher similarity; workers in similar (same) work types are regarded as workers with higher similarity, workers operating the same equipment are regarded as workers with higher similarity, and so on.

Step 505: determining the skills that need to be recommended based on the skills of the workers with higher similarity determined in step 504. For example, skills that are not possessed by the worker corresponding to the worker number logged in the worker management system in step 501 while possessed by workers with higher similarity determined in step 504 can be determined as skills that need to be recommended.

Step 506: determining whether skills that need to be recommended have been recommended, if so, execute step 512 and end the flow; otherwise, execute step 507 and subsequent steps.

Step 507: recommending skills to the worker corresponding to the worker number.

Step 508: displaying the recommended skills in multiple display methods.

Step 509: receiving feedback from the worker corresponding to the worker number. The feedback content includes: number of tasks completed during this login, newly mastered skills during this login, operation object operated during this login, etc.

Step 510: updating the knowledge graph based on the feedback. It can be seen that the knowledge graph is in a dynamic update state, that is the knowledge graph is in a state that can be updated in real time.

The exemplary process of the implementation of the teachings herein is described in detail above by taking a worker training scenario as an example. Those skilled in the art may realize that this description is only exemplary and is not used to limit the protection scope of the embodiments of the present disclosure.

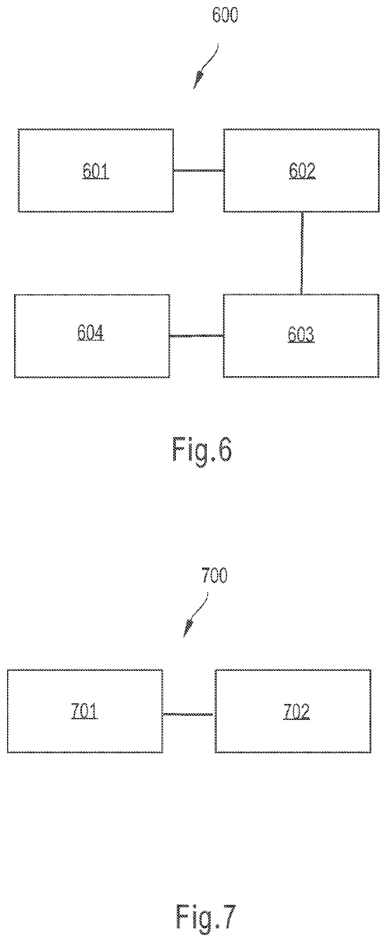

FIG. 6 is a block diagram of a device for intelligently providing recommendation information incorporating teachings of the present disclosure. As shown in FIG. 6, the device 600 for intelligently providing recommendation information includes:
a first determining module 601, configured to determine user attribute parameters corresponding to a user identifier; a second determining module 602, configured to determine a score value corresponding to the user identifier by inputting the user attribute parameters into a scoring model; a third determining module 603, configured to determine recommendation information corresponding to the user identifier based on the score value and a knowledge graph related to the user; and a providing module 604, configured to provide the recommended information

In some embodiments, the first determining module 601 is configured to execute at least one of the following: obtaining working time corresponding to the user identifier from a user information database; obtaining historical task amount corresponding to the user identifier from a user information database; obtaining current task corresponding to the user identifier from a user information database; obtaining a skill level value corresponding to the user identifier from a user information database; obtaining training time corresponding to the user identifier from a user information database; obtaining the number of skills corresponding to the user identifier from the knowledge graph.

In some embodiments, the user attribute parameters include multiple categories and the scoring model is a trained machine learning model including multiple dimensions, wherein each dimension corresponds to each category of the user attribute parameters.

In some embodiments, the knowledge graph includes user entities, skill entities, and operation object entities; wherein the data source used to construct the knowledge graph includes at least one of the following: structured data; unstructured data; semi-structured data.

In some embodiments, the third determining module 603 is configured to: determine a skill set corresponding to the level range to which the score value belongs; determine a skill corresponding to the user identifier stored in the knowledge graph; remove the skill corresponding to the user identifier from the skill set; and determine the recommended information corresponding to the user identifier based on the remaining skills in the skill set; or determine a similar user with a score value similar to the score value; determine a skill corresponding to the user identifier of the similar user stored in the knowledge graph; and determine the recommendation information corresponding to the user identifier based on the skill corresponding to the user identifier of the similar user; or determine a similar user who is similar to the user corresponding to the user identifier based on the knowledge graph; determine a skill corresponding to the user identifier of the similar user stored in the knowledge graph; determine the recommendation information corresponding to the user identifier based on the skill corresponding to the user identifier of the similar user.

In some embodiments, the third determining module 603 is configured to determine a first set of similar users based on the knowledge graph, wherein the first set of similar users includes similar users of the user corresponding to the user identifier; determine a second set of similar users based on a score value comparison process, wherein the second set of similar users includes similar users of the user corresponding to the user identifier; determine the intersection of the first set of similar users and the second set of similar users; and determine the recommendation information corresponding to the user identifier based on a skill of the users in the intersection stored in the knowledge graph and a skill of the user corresponding to the identifier stored in the knowledge graph.

FIG. 7 is a structural diagram of a device for intelligently providing recommendation information with a memory-processor architecture incorporating teachings of the present disclosure. As shown in FIG. 7, the device 700 includes a processor 701, a memory 702, and a computer program stored on the memory 702 and running on the processor 701. The computer program is executed by the processor 701 to perform one or more of the methods for intelligently providing recommendation information described herein.

Among them, the memory 702 may be specifically implemented as various storage media such as an electrically erasable programmable read-only memory (EEPROM), a flash memory (Flash memory), and a programmable program read-only memory (PROM). The processor 701 may be implemented to include one or more central processing units or one or more field programmable gate arrays, where the field programmable gate array integrates one or more central processing unit cores. Specifically, the central processing unit or central processing unit core can be implemented as a CPU, MCU, DSP, or the like.

It should be noted that not all the steps and modules in the foregoing processes and the various structural diagrams are necessary, and some steps or modules may be omitted according to actual needs. The order of execution of each step is not fixed and can be adjusted as needed. The division of each module is only for the convenience of description of the functional division. In actual implementation, one module can be implemented by multiple modules, and the functions of multiple modules can also be implemented by the same module. These modules can be located in the same device. It can also be located in different devices.

The hardware modules in the various embodiments may be implemented mechanically or electronically. For example, a hardware module can include specially designed permanent circuits or logic devices (such as dedicated processors such as FPGAs or ASICs) for performing specific operations. The hardware modules may also include programmable logic devices or circuits (such as including general purpose processors or other programmable processors) that are temporarily configured by software for performing particular operations. The hardware module can be implemented by mechanical means, by using a dedicated permanent circuit, or by using a temporarily configured circuit (such as software configuration), which can be determined based on cost and time considerations.

The present disclosure also provides a machine readable storage medium storing instructions for causing a machine to perform a method as described herein. In particular, a system or apparatus equipped with a storage medium on which software program code implementing the functions of any of the above-described embodiments is stored, and a computer (or CPU or MPU) of the system or apparatus may be stored Reading and executing the program code stored in the storage medium. In addition, some or all of the actual operations may be performed by an operating system or the like operating on a computer based on instructions of the program code. It is also possible to write the program code read out from the storage medium into a memory set in an expansion board inserted into the computer or into a memory set in an extension unit connected to the computer, and then install the program based on the instruction of the program code. The expansion board or the CPU or the like on the expansion unit performs part and all of the actual operations to implement the functions of any of the above embodiments.

Embodiments of storage medium for providing program code include floppy disks, hard disks, magneto-optical disks, optical disks (such as CD-ROM, CD-R, CD-RW, DVD-ROM, DVD-RAM, DVD-RW, DVD+RW), Tape, non-volatile memory card and ROM. In some embodiments, the program code can be downloaded from a server computer or cloud by a communication network.

The above description includes example embodiments of the present teachings and is not intended to limit the scope of the present disclosure. Any modifications, equivalent substitutions, improvements, etc. made within the spirit and scopes of the present invention are intended to be included within the scope of the present disclosure.

The present disclosure has been shown and described in detail with reference to the accompanying drawings and the preferred embodiments thereof, but the disclosure is not limited to these disclosed embodiments, and those skilled in the art may know that the various embodiments described above may be combined. The code review means in the present disclosure obtains more embodiments of the teachings herein, and these embodiments are also within the scope of the present disclosure.

What is claimed is:

1. A method for intelligently providing recommendation information, the method comprising:
determining user attribute parameters corresponding to a user identifier;
determining a score value corresponding to the user identifier by inputting the user attribute parameters into a scoring model;
determining recommendation information corresponding to the user identifier based on the score value and a knowledge graph related to the user; and
providing the recommended information.

2. The method according to claim 1, wherein determining user attribute parameters corresponding to a user identifier comprises at least one option selected from the group consisting of:
obtaining working time corresponding to the user identifier from a user information database,
obtaining historical task amount corresponding to the user identifier from a user information database,
obtaining current task corresponding to the user identifier from a user information database,
obtaining a skill level value corresponding to the user identifier from a user information database,
obtaining training time corresponding to the user identifier from a user information database, and
obtaining the number of skills corresponding to the user identifier from the knowledge graph.

3. The method according to claim 1, wherein:
the user attribute parameters include multiple categories;
the scoring model comprises a trained machine learning model including multiple dimensions; and
each dimension corresponds to each category of the user attribute parameters.

4. The method according to claim 1, wherein the knowledge graph includes user entities, skill entities and operation object entities.

5. The method according to claim 4, wherein determining recommendation information corresponding to the user identifier based on the score value and a knowledge graph related to the user comprises:
determining a skill set corresponding to the level range to which the score value belongs;
determining a skill corresponding to the user identifier stored in the knowledge graph;
removing the skill corresponding to the user identifier from the skill set; and
determining the recommended information corresponding to the user identifier based on the remaining skills in the skill set.

6. The method according to claim 4, wherein determining recommendation information corresponding to the user identifier based on the score value and a knowledge graph related to the user comprises:
determining a first set of similar users based on the knowledge graph, wherein the first set of similar users includes similar users of the user corresponding to the user identifier;
determining a second set of similar users based on a score value comparison process, wherein the second set of similar users includes similar users of the user corresponding to the user identifier;
determining the intersection of the first set of similar users and the second set of similar users; and
determining the recommendation information corresponding to the user identifier based on a skill of the users in the intersection stored in the knowledge graph and a skill of the user corresponding to the user identifier stored in the knowledge graph.

7. A device for intelligently providing recommendation information, the device comprising:
a first determining module configured to determine user attribute parameters corresponding to a user identifier;
a second determining module configured to determine a score value corresponding to the user identifier by inputting the user attribute parameters into a scoring model;
a third determining module configured to determine recommendation information corresponding to the user identifier based on the score value and a knowledge graph related to the user; and
a providing module configured to provide the recommended information.

8. The device according to claim 7, wherein the first determining module is further configured to execute at least one of the following option selected from the group consisting of:
obtaining working time corresponding to the user identifier from a user information database;
obtaining historical task amount corresponding to the user identifier from a user information database;
obtaining current task corresponding to the user identifier from a user information database;
obtaining a skill level value corresponding to the user identifier from a user information database;
obtaining training time corresponding to the user identifier from a user information database; and
obtaining the number of skills corresponding to the user identifier from the knowledge graph.

9. The device according to claim 7, wherein:
the user attribute parameters include multiple categories;
the scoring model is a trained machine learning model including multiple dimensions; and
each dimension corresponds to each category of the user attribute parameters.

10. The device according to claim 7, wherein the knowledge graph includes user entities, skill entities, and operation object entities.

11. The device according to claim 10, wherein the third determining module is further configured to:
determine a skill set corresponding to the level range to which the score value belongs;
determine a skill corresponding to the user identifier stored in the knowledge graph;
remove the skill corresponding to the user identifier from the skill set; and
determine the recommended information corresponding to the user identifier based on the remaining skills in the skill set.

12. The device according to claim 10, wherein the third determining module is further configured to:
determine a first set of similar users based on the knowledge graph, wherein the first set of similar users includes similar users of the user corresponding to the user identifier;
determine a second set of similar users based on a score value comparison process, the second set of similar users includes similar users of the user corresponding to the user identifier;
determine the intersection of the first set of similar users and the second set of similar users; and
determine the recommendation information corresponding to the user identifier based on a skill of the users in the intersection stored in the knowledge graph and a skill of the user corresponding to the identifier stored in the knowledge graph.

13. A device for intelligently providing recommendation information, the device comprising:
a processor; and
a memory storing an application program;
wherein the application program is executable by the processor and causes the processor to execute a method for intelligently providing recommendation information, the method comprising:
determining user attribute parameters corresponding to a user identifier;
determining a score value corresponding to the user identifier by inputting the user attribute parameters into a scoring model;
determining recommendation information corresponding to the user identifier based on the score value and a knowledge graph related to the user; and
providing the recommended information.

14. (canceled)

15. The method according to claim 4, wherein determining recommendation information corresponding to the user identifier based on the score value and a knowledge graph related to the user comprises:
determining a similar user with a score value similar to the score value;
determining a skill corresponding to the user identifier of the similar user stored in the knowledge graph; and
determining the recommendation information corresponding to the user identifier based on the skill corresponding to the user identifier of the similar user.
determining a similar user who is similar to the user corresponding to the user identifier based on the knowledge graph; determining a skill corresponding to the user identifier of the similar user stored in the knowledge graph; determining the recommendation information corresponding to the user identifier based on the skill corresponding to the user identifier of the similar user.

16. The method according to claim 4, wherein determining recommendation information corresponding to the user identifier based on the score value and a knowledge graph related to the user comprises:
determining a similar user with a score value similar to the score;
determining a similar user who is similar to the user corresponding to the user identifier based on the knowledge graph;
determining a skill corresponding to the user identifier of the similar user stored in the knowledge graph; and
determining the recommendation information corresponding to the user identifier based on the skill corresponding to the user identifier of the similar user.

17. The device according to claim 10, wherein the third determining module is further configured to:
determine a similar user with a score value similar to the score value;
determine a skill corresponding to the user identifier of the similar user stored in the knowledge graph; and
determine the recommendation information corresponding to the user identifier based on the skill corresponding to the user identifier of the similar user.

18. The device according to claim 10, wherein the third determining module is further configured to:
determine a similar user who is similar to the user corresponding to the user identifier based on the knowledge graph;
determine a skill corresponding to the user identifier of the similar user stored in the knowledge graph; and
determine the recommendation information corresponding to the user identifier based on the skill corresponding to the user identifier of the similar user.
